(19) United States
(12) Patent Application Publication
(10) Pub. No.: US 2010/0007260 A1
(43) Pub. Date: Jan. 14, 2010

(54) SPARK PLUG HAVING AN INSULATOR COMPOSED OF HIGH-PURITY ALUMINIUM OXIDE CERAMIC

(76) Inventors: Werner Niessner, Steinheim (DE); Martin Knoch, Coburg (DE); Klaus Stetter, Sonnefeld (DE)

Correspondence Address: Walter A. Hackler;Patent Law Office, 2372 S.E. Bristol Street , Suite B, Newport Beach, CA, 92660-0755, US

(21) Appl. No.: 12/448,116

(22) PCT Filed: Dec. 13, 2007
(86) PCT No.: PCT/EP2007/010974

§ 371 Date: Sep. 18, 2009

(30) Foreign Application Priority Data
Dec. 20, 2006 (DE) 10 2006 061 907.2

(51) Int. Cl. H01T 13/00

(52) U.S. Cl. 313/118

(57) ABSTRACT

A spark plug is described for Otto-cycle engines having a metallic spark plug body, having a center electrode, having a ceramic insulator, which is arranged between the center electrode and the body and is based on aluminium oxide, and having at least one earth electrode. The invention provides for the insulator to be composed of 0.01% by weight to 1% by weight of magnesium oxide, at most 0.3% by weight of natural and/or impurities, with the rest being aluminium oxide, and being formed by solid-phase sintering so that it is very largely free of glass phases.

The present invention relates to a spark plug having the features defined in the preamble of Claim 1. A spark plug of that type has been known from EP 0 954 074 B1.

Advanced Otto-cycle engines need more space in the cylinder head for inlet valves and outlet valves, and this is one of the causes that have led to the current demand for spark plugs of smaller diameter compared with previous spark plugs. Slender spark plugs need a slender insulator. This in turn places higher demands on the mechanical strength and the dielectric properties, especially the electric breakdown strength of the insulator in the spark plug, which usually is composed of an aluminium oxide ceramic material.

JP-A 63-190753 discloses an insulator composed of an aluminium oxide ceramic which is obtained by mixing 95% by weight of alumina powder, having a mean particle size of 0.1 μm to 0.5 μm, with yttrium oxide, magnesium oxide and lanthanum oxide, and liquid-phase pressing and sintering. The yttrium oxide, the magnesium oxide and the lanthanum oxide together account for 5% by weight of the mixture and serve as sintering aid, leading during the sintering process to a liquid phase with a melting point far below the melting point of the aluminium oxide. The liquid phase spreads at the boundaries of the aluminium oxide particles and is said to inhibit their growth during the sintering process so that the sintered insulator still exhibits a very finely grained structure. According to the disclosure of JP-A 63-190753, the fine structure preserved by the sintering aids has the effect to increase the length of the paths enriched with sintering aids, which extend along the boundaries of the aluminium oxide particles and via which the electric charges would move in the case of a breakdown, thereby increasing the dielectric strength of the insulator. On the other hand, the fine pores, which are especially numerous in the finely structured sintered insulators and whose number increases as the content of aluminium oxide in the insulator rises, has an oppositely directed influence on the dielectric strength because the proportion of the sintering aids, that would be capable of closing the pores by the formation of a liquid phase, drops simultaneously.

In order to overcome that difficulty, EP 0 954 074 B1 describes a spark plug with an insulator which, while having a higher content of aluminium oxide than the insulator known from JP-A 63-190753, namely 95% by weight to 99.7% by weight of aluminium oxide, avoids the finely grained structure of the material of the insulator known from JP-A 63-190753 in order to reduce the number of pores and proposes instead to have at least half the insulator formed from aluminium oxide particles of a particle size not below 20 μm. For producing that insulator, aluminium oxide powder having a mean particle size of not exceeding 1 μm is mixed with 0.3 to 5% by weight of a sintering aid, and is pressed and liquid-phase sintered at a temperature of between 1450° C. and 1700° C. The sintering aid is selected to ensure that it does not inhibit the growth of the aluminium oxide powder particles during the sintering process. The sintering process is continued until at least half the aluminium oxide has grown to particles of a size of 20 μm or over. During sintering, the sintering aid forms a liquid phase that is said to favor a small pore volume.

According to the disclosure of EP 0 954 074 B1, one thus obtains a breakdown strength for an insulator for a spark plug of, for example, 37 kV because—so it is argued—on the one hand the particle growth has reduced the number of particle boundaries along which an electric breakthrough would propagate and because on the other hand the number of triple points in the particle boundaries, along which the glass phases formed by the sintering aids would preferably deposit and from which a breakthrough would preferably start out, likewise has been reduced.

By way of comparison, EP 0 954 075 B1 discusses an insulator made from 100% aluminium oxide with a purity of 99.9% and finds that—when tested in oil—that insulator showed the by far lowest breakthrough voltage, the highest number of pores and the by far lowest insulation resistance so that it was judged to be unsuitable.

### SUMMARY OF THE INVENTION

It is an object of the present invention to further improve the dielectric strength of the insulator of a spark plug both at room temperature and, especially, also at the high temperatures encountered in Otto-cycle engines at operating temperature.

That object is achieved by a spark plug having the features defined in Claim 1. Advantageous further developments of the invention are the subject-matter of the sub-claims.

The spark plug according to the invention comprises an insulator which contains 0.01% by weight to 1% by weight of magnesium oxide, a maximum of 0.3% by weight of natural impurities and/or impurities resulting from the production process, the rest being aluminium oxide, and which is formed by solid-phase sintering so that it is very largely free from glass phases.

Surprisingly, it has been found that spark plugs having such an insulator provide substantial advantages over the prior art:
The withstand voltage of the insulator is higher than that of prior-art insulators. Breakthrough voltages of 50 kV/mm and higher were measured at room temperature. This allows the production of spark plugs with an insulator wall thickness as small as 0.8 mm and, accordingly, a break-through voltage of 40 kV and higher.
The high withstand voltage is retained at the operating temperatures of up to 900° C. encountered in Otto-cycle engines at normal operating temperature.
The insulators show increased mechanical strength, especially increased bending strength and bending strength at alternating stress.
Compared with the insulators of conventional spark plugs, the insulators have a thermal conductivity higher by up to 15%. This allows the insulator base of the spark plug, i.e. that section of the insulator which projects into the cylinder of the Otto-cycle engine, to be extended in length without thereby increasing the thermal value. The advantage of such a longer insulator base is seen in a higher shunt resistance of the spark plug and, accordingly, a clear improvement of the ignition properties under cold starting and repeated starting conditions.
The insulator of the spark plug according to the invention shows higher chemical resistance which contributes toward extending the service life of the spark plug.
The higher withstand voltage allows the insulators to be made thinner and, accordingly, more slender. Slender spark plugs can be given narrower threads, for example M12 and M10 threads, thereby providing more space in the cylinder head for inlet valves and outlet valves of the engine.

Preferably, the insulator of the novel spark plug contains 0.03% by weight to 0.15% by weight of magnesium oxide. Even small additions of magnesium oxide already result in reduced crystal growth of the aluminium oxide during solid-phase sintering. That effect becomes technically significant at a content of 0.03% by weight and higher. From the point a content of magnesium oxide of more than 0.15% by weight is reached, that effect will no longer increase significantly.

In addition to aluminium oxide and magnesium oxide, the insulator contains only natural impurities and/or impurities resulting from the production process. In particular, the invention does without any addition of sintering aids such as sodium oxide, yttrium oxide, lanthanum oxide, silicon oxide, barium oxide, boron oxide and the like, which, at the temperatures at which solid-phase sintering of aluminium oxide can be effected, would form a liquid phase from which a glass phase would develop after solidification. Accordingly, any minor glass phases that might be detectable in an insulator according to the invention necessarily must be due to the natural impurities and/or impurities resulting from the production process present in the aluminium oxide. This is what is meant by Claim 1 when it states that the insulator is very largely free from glass phases.

Preferably, the insulator of the spark plug according to the invention contains more than 99.7% by weight of aluminium oxide. In that case, any glass phases that may be due to the remaining impurities will not be likely to notably impair the dielectric strength of the insulator still further.

The density preferred for an insulator of a spark plug according to the invention is at least 3.85 g cm⁻³. Such a high density can be reached when a very fine aluminium oxide powder is used, preferably one with a mean particle size of less than 1 μm, when the insulator blanks are sufficiently compressed prior to sintering, especially by isostatic pressing, and when the sintering temperature and the sintering time are adjusted one to the other so that an insulator is obtained in which 90% by weight of the aluminium oxide have particle sizes of less than 5 μm, or even better particle sizes of less than 3 μm. Suited as a temperature for the solid-phase sintering process is a temperature in the range of 1600° C. to 1700° C., i.e. clearly below the melting temperature of aluminium oxide which is above 20000° C.

### BRIEF DESCRIPTION OF THE DRAWING

The advantages and features of the present invention will be better understood by the following description when considered in conjunction with the accompanying drawings in which:

FIG. 1 illustrates a spark plug in accordance with the present invention.

### DETAILED DESCRIPTION

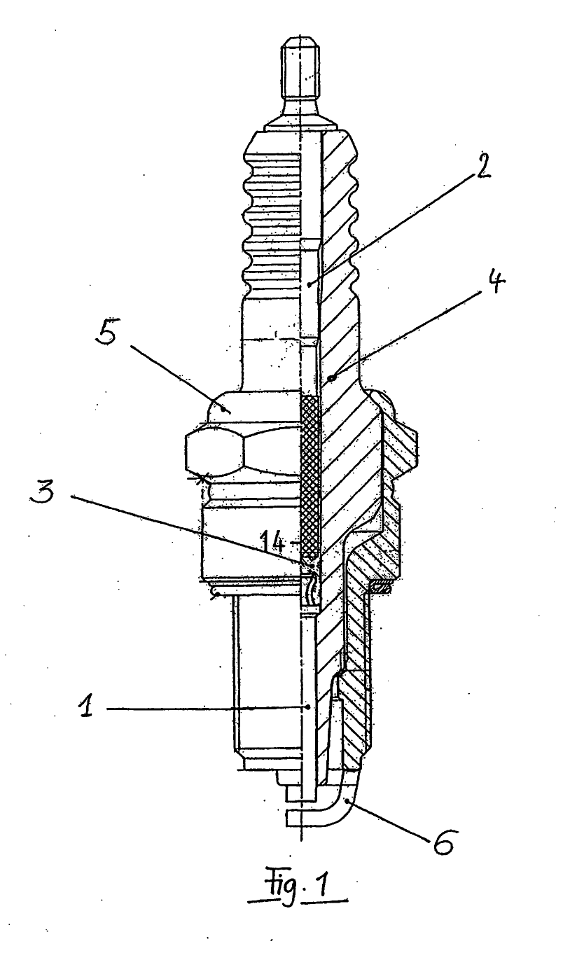

FIG. 1 shows a side view, sectioned in part, of the typical structure of a spark plug according to the invention, comprising a central electrode 1 and, in alignment with the latter, an igniter 2, which are arranged at a spacing one behind the other in an insulator 4 according to the invention, namely in a longitudinal channel in which they are interconnected by an electrically conductive glass phase 3. The insulator 4 is fitted in a metallic body 5 in which it is located by beading and electric upsetting. A ground electrode 6 mounted on the body 5 is bent toward the central electrode 1 and is arranged opposite the latter so as to form a discharge gap of defined spacing.

The insulator consists, for example, of 99.8% by weight of aluminium oxide, approximately 0.1% by weight of magnesium oxide and, for the rest, of natural impurities and/or impurities resulting from the production process. It is formed by solid-phase sintering and contains no glassy secondary phase that could be detected by radiography.

The insulator according to the invention can be mounted in the body 5 of a spark plug in the known way so that the existing production means and methods for the assembly of the insulator 4, just as the central electrode 1 and the igniter 2, can be retained. The required ceramic-metal compound is obtained by the use of an electrically conductive composite glass. The electrically conductive vitreous mass 3 guarantees the electric connection between the central electrode 1 and the igniter 2 and serves in addition to locate the central electrode 1 in the insulator 4 in pressure-tight fashion.

### LIST OF REFERENCE NUMERALS

1. Central electrode
2. Igniter
3. Glass phase
4. Insulator
5. Body
6. Ground electrode

What is claimed is:

1. Spark plug for Otto-cycle engines having a metallic spark plug body, a central electrode, a ceramic insulator, which is arranged between the central electrode and the body and is based on aluminium oxide, and at least one ground electrode, characterized in that the insulator contains 0.01% by weight to 1% by weight of magnesium oxide, a maximum of 0.3% by weight of natural impurities and/or impurities resulting from the production process, the rest being aluminium oxide, and which is formed by solid-phase sintering so that it is very largely free from glass phases.

2. The spark plug as defined in claim 1, characterized in that the content of magnesium oxide is 0.03% by weight to 0.5% by weight.

3. The spark plug as defined in claim 1, characterized in that the insulator contains more than 99.7% by weight of aluminium oxide.

4. The spark plug as defined in claim 1, characterized in that the insulator has a density of at least 3.85 g cm⁻³.

5. The spark plug as defined in claim 1, characterized in that the insulator has a density of 3.90 g cm⁻³+−0.02 g cm⁻³.

6. The spark plug as defined in claim 1, characterized in that 90% by weight of the aluminium oxide present in the insulator have crystallite sizes of less than 5 μm (mean diameter).

7. The spark plug as defined in claim 6, characterized in that 90% by weight of the aluminium oxide present in the insulator have crystallite sizes of less than 3 μm.

8. The spark plug as defined in claim 1, characterized in that the content of magnesium oxide is 0.03% by weight to 0.5% by weight and that the insulator contains more than 99.7% by weight of aluminium oxide.
